(19) United States
(12) Patent Application Publication
(10) Pub. No.: US 2010/0120278 A1
(43) Pub. Date: May 13, 2010

(54) MULTI-ANGULAR POWER ADAPTER

(76) Inventor: Chun-Lian Yang, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,982

(22) Filed: Oct. 26, 2005

(51) Int. Cl. H01R 29/00

(52) U.S. Cl. 439/171

(57) ABSTRACT

This invention discloses a multi-angular power adapter particularly used for electrically charging a small electric appliance and having a multi-angular function. The multi-angular power adapter includes a casing, a circuit section, an output power cord, and a connector section connected to an external power supply, characterized in that the connector section includes a fixed base, a movable connector base corresponding to the fixed base, and a limit section for restricting the movements of the movable connector base. The fixed base installed on the casing includes at least two fixed contact points electrically connected to the circuit section, and the movable connector base operates in coordination with the fixed base to change an angle in a plane, and the movable connector base includes two movable contact points respectively in contact with the two fixed contact point and electrically connected with the two insert pins of the movable connector base.

### BACKGROUND OF THE INVENTION

1. Field of the Invention

The present invention relates to a multi-angular power adapter which is a power conversion related equipment, and more particularly to a power adapter for electrically charging a small electric appliance.

2. Description of Related Art

In general, the insert pins of a power adapter used for electrically charging a small electric appliance have a fixed direction, and it is very common for users to plug in the connectors of several electric appliances on a socket. There may not be sufficient space for plugging the connector of an electric appliance due to the adjacent connectors, and the electric appliance cannot be plugged or used, and thus such prior art causes inconvenience to users. Furthermore, the insert pins of the power adapter of this kind may not fit different types of sockets (such as the two parallel plate insert pins, two non-parallel plate insert pins, or two cylindrical insert pins, etc) required in different countries or districts requiring. The power adapter of this sort cannot be used for different types of connections required in different countries or districts.

Therefore, finding a way of designing a power adapter that can overcome the foregoing shortcomings of the prior art is a major objective that the inventor of the present invention intends to achieve.

### SUMMARY OF THE INVENTION

Therefore, the present invention to provide a multi-angular power adapter that adopts a movable connector section to change the inserting angle of the connector section and solve the problem of the prior art that the connector cannot be inserted due to the limited space and interference of the adjacent connectors.

Moreover the present invention is to provide a multi-angular power adapter of the invention that adopts a detachable technique applied to the movable connector section, so as to overcome the shortcoming of the prior art that cannot fit the sockets in different countries or districts.

Furthermore the present invention is to provide a multi-angular power adapter that adopts an axial limit technique and a circumferential limit technique to overcome the technical issue of the movable connector section being loosened and mislocated.

One aspect of the present invention provides a multi-angular power adapter that comprises a casing, a circuit section, an output power cord, and a connector section connected to an external power supply, characterized in that the connector section comprises a fixed base, a movable connector base corresponding to the fixed base, and a limit section for restricting the movements of the movable connector base.

The fixed base is installed onto the casing and includes at least two fixed contact points electrically connected to a circuit section.

The movable connector base operates in coordination with the fixed base and can change its angle in a plane, said movable connector base has two insert pins, and the movable connector base includes two movable contact points respectively in contact with the two fixed contact points and electrically connected with two insert pins of the movable connector base.

If the space along the longitudinal direction of the socket is occupied or restricted and the power adapter cannot be used, then the direction of the insert pin can be changed to another angle for a transversal insertion or an aslant insertion to assure the use of the power adapter.

Further, the limit section includes an axial limit assembly installed between the fixed base and the movable connector base, and the limit section also includes a circumferential limit assembly disposed between the casing and the movable connector base. The axial limit assembly and the circumferential limit assembly are used to fix the movable connector base in the axial direction and the circumferential direction respectively to prevent the power adapter from being loosened or mislocated.

Further, the snap-in axial limit assembly includes a fixed latch member and a movable latch groove, and the fixed latch member is installed on an internal lateral side of the fixed base, and the movable latch groove is installed on the external edge of the movable connector base which is in contact with the fixed base. The fixed latch member can be accommodated into the movable latch groove. The snap-in axial limit assembly is easy to be installed and removed, and it thus can be switched to other inserting type of insert pins to fit the socket of different countries or districts and can assure the use of the power adapter in different countries or districts.

### BRIEF DESCRIPTION OF THE DRAWINGS

FIG. 1 is a schematic view of the disassembled parts of a power adapter of the invention;

FIG. 2 is a cross-sectional view of a section of a power adapter after an axial limit assembly is assembled according to FIG. 1;

FIG. 3 is a cross-sectional view of a section of a power adapter after a circumferential limit assembly is assembled according to FIG. 1;

FIG. 4 is a schematic view of a connector section adopting a continuous serrated latch groove in the power adapter of the invention;

FIG. 5 is a schematic view of a connector section adopting a circular fixed contact point in the power adapter of the invention;

FIG. 6 is a schematic view of a connector section adopting a circular plate with a circular fixed contact point in the power adapter of the invention; and

FIG. 7 is a schematic view of a connector section adopting an arc fixed contact point in a power adapter of the invention.

### DETAILED DESCRIPTION OF PREFERRED EMBODIMENTS

The present invention will now be described in more detail hereinafter with reference to the accompanying drawings that show various embodiments of the invention.

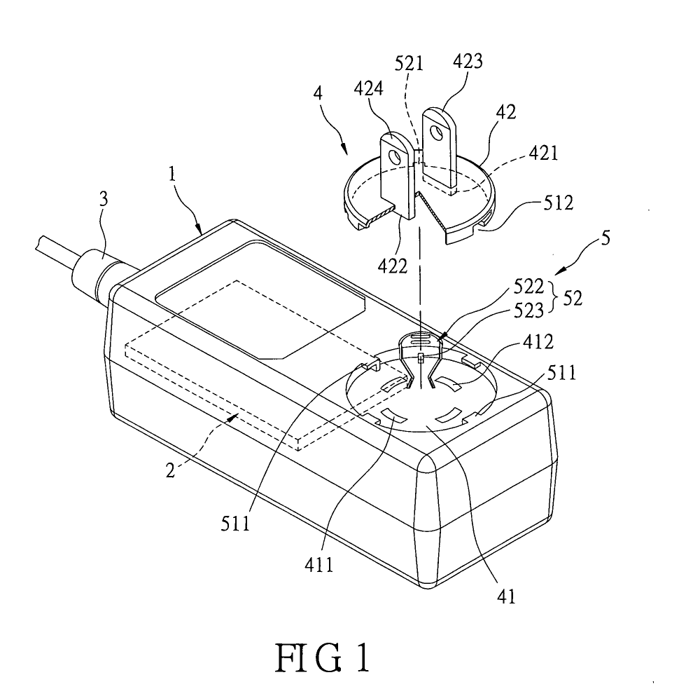

Referring to FIGS. 1 to 7 for the multi-angular power adapter of the present invention, the power adapter comprises a casing 1, a circuit section 2, an output power cord 3, and a connector section 4 connected to an external power supply.

The connector section 4 includes a fixed base 41 and a movable connector base 42, wherein the fixed base 41 is disposed on the casing 1, and the movable connector base 42 operates in coordination with the fixed base 41 and can change its angle on a plane. The fixed base 41 also includes at least two fixed contact points 411, 412 separately and electrically connected to the circuit section 2. The movable connector base 42 includes two movable contact points 421, 422 respectively in contact with the two fixed contact points 411, 412 and electrically connected to two insert pins 423, 424 of the movable connector base 42. The connector section 4 also includes a limit section 5 for restricting the movements of the movable connector base 42.

If the space along the longitudinal direction of the socket is occupied or restricted and the power adapter cannot be used, the direction of the insert pins 423, 424 can change to another angle such as an angle for a transversal insertion or an aslant insertion to assure the use of the power adapter. Further, the limit section 5 has an effect of fixing the movable connector base 42 to prevent the movable connector base 42 from being loosened or mislocated.

Referring to FIGS. 1 to 3, the limit section 5 includes an axial limit assembly 51 or a circumferential limit assembly 52 or both.

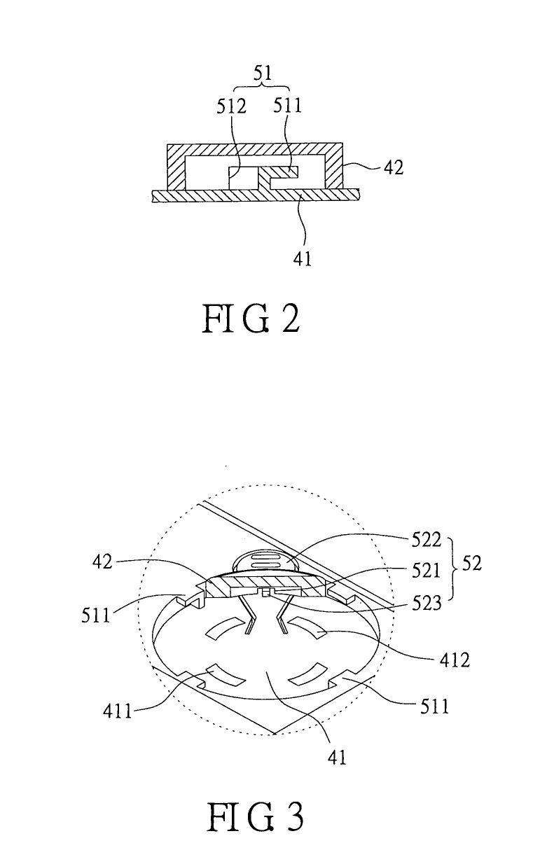

Referring to FIGS. 1 and 2, the axial limit assembly 51 is disposed between the fixed base 41 and the movable connector base 42 for fixing the movable connector base 42 and the fixed base 41 along the axial direction to prevent the movable connector base 42 from falling out along the axial direction.

Referring to FIGS. 1 and 3, the circumferential limit assembly 52 is disposed between the casing 1 and the movable connector base 42 for fixing the movable connector base 42 and the casing 1 along the circumferential direction to prevent the movable connector base 42 from being mislocated along the circumferential direction.

Referring to FIG. 2, one of the many structural designs of the axial limit assembly 51 is introduced here. The snap-in axial limit assembly 51 includes a fixed latch member 511 and a movable latch groove 512, and the fixed latch member 511 is disposed on an internal side of the fixed base 41, and the movable latch groove 512 used for containing the fixed latch member 511 is disposed at an external edge of the movable connector base that is in contact with the fixed base 41. If the movable connector base 42 is installed into the fixed base 41, the fixed latch member 511 will be latched into the movable latch groove 512. Since the fixed base 41 is fixed onto the casing 1, therefore the movable connector base 42 is fixed along the axial direction, and the movable connector base 42 will not be loosened or fallen out.

Referring to FIG. 2 again, there are many solutions for the design of the shape of the movable latch groove 512. For a convenient disassembling, the movable latch groove 512 preferably has an L-shape groove with an opening at the bottom to facilitating its manufacture. If the movable connector base 42 installs a fixed base 41 therein, the fixed latch member 511 is latched into the longitudinal groove of the movable latch groove 512 from the opening at the bottom of the L-shape movable latch groove 512. If the fixed latch member 511 reaches the position of the transversal groove of the L-shape movable latch groove 512, the movable connector base 42 is turned to latch the fixed latch member 511 into the transversal groove of the L-shape movable latch groove 512, and the movable connector base 42 is fixed along the axial direction. Therefore, the direction of the insert pins can be changed to fit the socket in different countries or districts, and thus users can use the power adapter in different countries.

Reference is made to FIG. 3. Like the aforementioned axial limit assembly 51, there are many solutions for the design of the circumferential limit assembly 52, and one of the examples is used for illustration. The circumferential limit assembly 52 includes a latch groove 521 and a fixed latch handle 522, and the latch groove 521 is disposed at a lower edge of the movable connector base 42, and the fixed latch handle 522 is disposed on the casing 1, and the fixed latch handle 522 is elastically connected to the casing 1. A latch member 523 is protruded from the fixed latch handle 522 at a position corresponding to the latch groove 521. After the movable connector base 42 is installed, the fixed latch handle 522 uses its elasticity to latch the latch member 523 into the latch groove 521 at the lower edge of the movable connector base 42, so that the movable connector base 42 is fixed along the circumferential direction and cannot be rotated. If it is necessary to remove the movable connector base 42, the fixed latch handle 522 is pressed to separate the latch member 523 from the latch groove 521, and then the effect of limiting the movable connector base 42 no longer exists. Therefore, the movable connector base 42 can be turned freely and removed easily. This design can be used alone or together with the axial limit assembly 51.

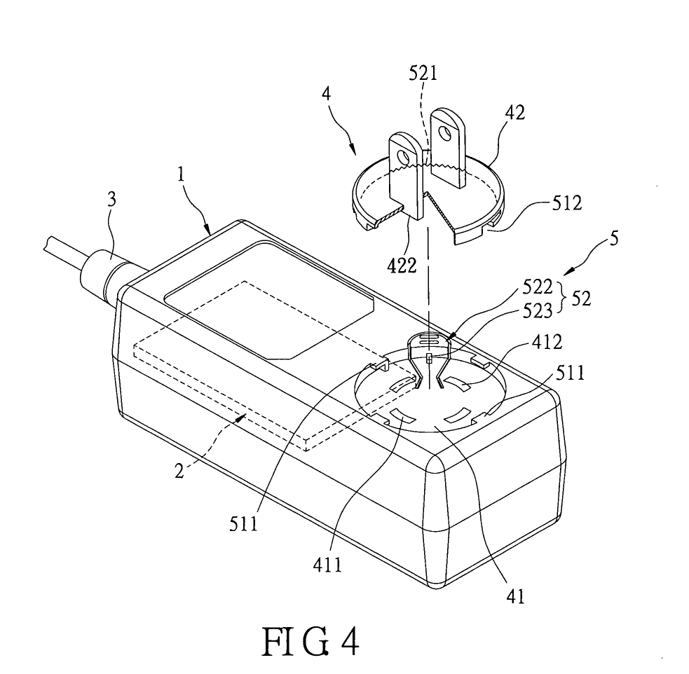

Referring to FIG. 4 for turning and changing the angle of the movable connector base 42, the latch groove 521 has a continuous serrated shape to assure that the latch member 523 can be latched into the latch groove 521 from several different positions to maximize its limit effect along the circumferential direction.

In addition, the number of the fixed contact points of the fixed base 41 can be 4, 6 or 8 according to different conditions and safety requirements of the electric appliances, and the fixed contact points are disposed symmetrically along the circumference to assure that the two movable contact points 421, 422 of the movable connector base 42 can be connected to the fixed contact points 411, 412 by a point contact.

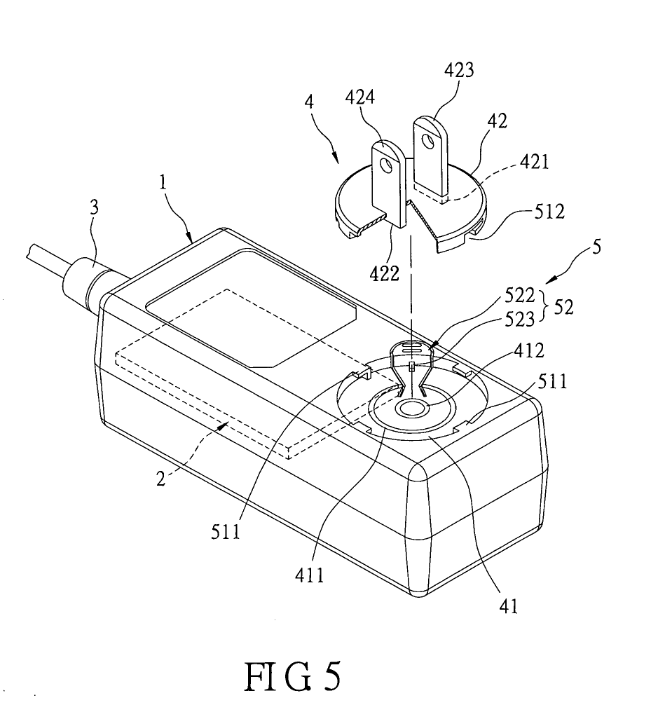

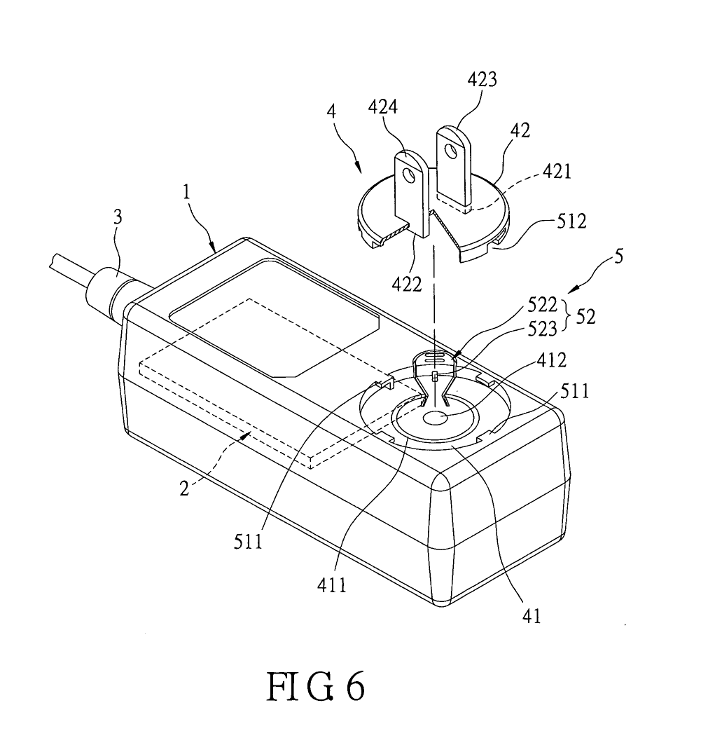

For the power adapter that can be turned to change the angle of the insert pin, the fixed contact points 411, 412 cannot be designed as a point contact for the electric connection, but the fixed contact points 411, 412 must be designed in the shape of a strap as shown in FIGS. 5 and 6. The fixed contact point 412 of the fixed base 41 is designed as a circular plate or a circular ring at the center, and the fixed contact point 411 and fixed contact point 412 are circular rings with different diameters.

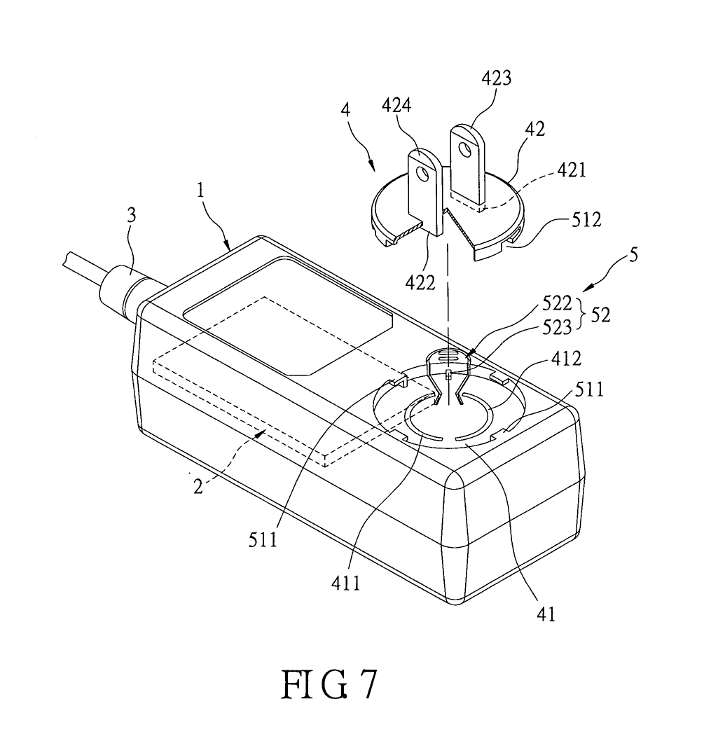

The fixed contact points 411, 412 of the fixed base 41 as shown in FIG. 7 can be designed as arc plates with equal diameter and symmetrically disposed along the circumference.

In summation of the description above, the multi-angular power adapter of the invention definitely can overcome the shortcomings of the prior arts, and further comply with the patent application requirements.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-angular power adapter, comprising a casing, a circuit section, an output power cord, and a connector section coupled to an external power supply, characterized in that:
said connector section comprises a fixed base, a movable connector base corresponding to said fixed base, and a limit section for restricting the movements of said movable connector base;
said fixed base is disposed on said casing and respectively and electrically coupled to at least two fixed contact points of said circuit section;
said movable connector base, operates in coordination with said fixed base and is capable of turning its angle on a plane, said movable connector base has two insert pins, and said movable connector base includes two movable contact points being respectively in contact with said two fixed contact points and electrically coupled with said two insert pins of said movable connector base.

2. The multi-angular power adapter of claim 1, wherein said limit section includes an axial limit assembly installed between said fixed base and said movable base.

3. The multi-angular power adapter of claim 1, wherein said limit section includes a circumferential limit assembly installed between said casing and said movable connector base.

4. The multi-angular power adapter of claim 3, wherein said circumferential limit assembly includes a latch groove disposed at a lower edge of said movable connector base and a fixed latch handle disposed on said casing, and said fixed latch handle is elastically coupled with said casing, and said fixed latch handle includes a latch member corresponding to the latch groove, and said latch member is latched with said latch groove.

5. The multi-angular power adapter of claim 4, wherein said latch groove is in a continuous serrated shape.

6. The multi-angular power adapter of claim 2, wherein said limit section includes a circumferential limit assembly installed between said casing and said movable connector base.

7. The multi-angular power adapter of claim 6, wherein said circumferential limit assembly includes a latch groove disposed at a lower edge of said movable connector base and a fixed latch handle disposed on said casing, and said fixed latch handle is elastically coupled with said casing, and said fixed latch handle includes a latch member corresponding to said latch groove, and said latch member is latched with said latch groove.

8. The multi-angular power adapter of claim 7, wherein said latch groove is in a continuous serrated shape.

9. The multi-angular power adapter of claim 1, wherein said axial limit assembly includes at least one fixed latch member and at least one movable latch groove, and said fixed latch member is disposed on an internal side of said fixed base, and said movable latch groove is disposed at an external edge of said movable connector base and in contact with said fixed base, and said fixed latch member is accommodated in said movable latch groove.

10. The multi-angular power adapter of claim 9, wherein said movable latch groove is an L-shape groove having an opening at the bottom of said movable latch groove.

11. The multi-angular power adapter of claim 1, wherein said fixed base includes four, six, or eight fixed contact points disposed symmetrically on a circumference.

12. The multi-angular power adapter of claim 1, wherein one of said fixed contact points is a circular plate or circular ring disposed at a center and said other fixed contact point is a circular ring having a diameter different than that of said fixed contact point.

13. The multi-angular power adapter of claim 1, wherein said fixed contact points are arc plates with equal diameter and disposed symmetrically on a circumference.
